(19) United States
(12) Patent Application Publication
(10) Pub. No.: US 2026/0093206 A1
(43) Pub. Date: Apr. 2, 2026

(54) COOLING STRUCTURE FOR FUSER

(71) Applicant: Hewlett-Packard Development Company, L.P., Spring, TX (US)

(72) Inventors: Hanjun LEE, Seongnam Si (KR); Seounghoon NOH, Seongnam Si (KR); Younghoon KIM, Seongnam Si (KR)

(21) Appl. No.: 19/111,415

(22) PCT Filed: Mar. 13, 2023
(86) PCT No.: PCT/US2023/015109

§ 371 Date: Mar. 13, 2025

(30) Foreign Application Priority Data
Sep. 13, 2022 (KR) 10-2022-0115107

(51) Int. Cl. G03G 21/20; G03G 15/20

(52) U.S. Cl. CPC G03G 21/206; G03G 15/2039; G03G 2221/1639; G03G 2221/1645

(57) ABSTRACT

A print apparatus includes a toner image forming portion to form a toner image on a print medium, a fuser to fuse the toner image onto the print medium, and an air blower. duct guides cooling air from the blower to the fuser. The duct includes an outer wall, an inlet formed in the outer wall facing the blower, and an outlet facing the fuser. A slider may be slidable in a width direction of the print medium so as to adjust an opening amount of the outlet. A flexible guide member is provided to guide the cooling air from the inlet of the duct to the outlet. An outlet side end portion of the flexible guide member is connected to an end portion of the slider and an inlet side end portion thereof is slidably supported on the outer wall of the duct.

### BACKGROUND

A print apparatus using an electrophotographic method supplies toner to an electrostatic latent image formed on a photoconductor to form a visible toner image on the photoconductor, transfers the toner image through an intermediate transfer medium or directly to a print medium, and fuses the transferred toner image onto the print medium. A fuser applies heat and pressure to the toner image transferred to the print medium and fuses the toner image onto the print medium. The fuser has a fusing area larger than the width of the print medium. The temperature of the fusing area is maintained at a certain fusing temperature.

### BRIEF DESCRIPTION OF THE DRAWINGS

FIG. 1 is a schematic plan view of an example of a print apparatus and shows a state in which first and second sliders are positioned at a first position where opening amounts of outlets of first and second ducts are at a reduced size consistent with the disclosure.

FIG. 2 is a schematic plan view of an example of a print apparatus and shows a state in which the first and second sliders are positioned at a second position where opening amounts of outlets of first and second ducts are at an increased size consistent with the disclosure.

FIG. 3 is a schematic plan view of an example of a print apparatus consistent with the disclosure.

FIG. 4 shows a state in which, in the example of the print apparatus shown in FIG. 3, the first slider is positioned at the first position where the opening amount of the outlet of the first duct is at the reduced size consistent with the disclosure.

FIG. 5 shows a state in which, in the example of the print apparatus shown in FIG. 3, the first slider is positioned at the second position where the opening amount of the outlet of the first duct is at the increased size consistent with the disclosure.

FIG. 6 is a schematic configuration diagram of an example of a print apparatus consistent with the disclosure.

### DETAILED DESCRIPTION

A print apparatus for printing an image on a print medium by an electrophotographic method includes a toner image forming portion forming a toner image on a print medium by an electrophotographic method, and a fuser fusing the toner image onto the print medium by applying heat and pressure to the print medium. The fuser has a fusing area having a width greater than a width of the largest print medium that may be used in the print apparatus. According to the size of the print medium, the fusing area may be divided into a passing area and a non-passing area. The passing area is an area through which the print medium passes, and the non-passing area is an area through which the print medium does not pass. The temperature of the fusing area is maintained at a certain fusing temperature. The higher the fusing temperature, the faster the fusing speed, but the high fusing temperature may negatively affect the lifespan of the fuser and other components of the print apparatus. For example, because the non-passing area does not lose heat to the print medium, the non-passing area may be relatively overheated compared to the passing area. Overheating may negatively affect the lifespan of the fuser. Also, in a case where the fuser is overheated, it may have a negative thermal effect on other components of the print apparatus around the fuser.

Cooling air may be supplied to the non-passing area so that the non-passing area is not overheated. The width of the non-passing area may vary depending on the size of the print medium used by the print apparatus. In consideration of this point, the print apparatus of the disclosure employs a variable duct structure capable of adjusting an area to which cooling air is supplied according to a change in the size of the non-passing area

A print apparatus according to an example of the disclosure includes a toner image forming portion that forms a toner image on a print medium, a fuser that fuses the toner image on the print medium, and a blower. An example of the variable duct structure may include a duct, a slider, and a flexible guide member. The duct guides the cooling air from the blower to the fuser. The duct includes an outer wall, an inlet formed in the outer wall to face the blower, and an outlet facing the fuser. The slider may be slid in a width direction of the print medium to adjust an opening amount of the outlet. The flexible guide member is provided to guide the cooling air from the inlet of the duct to the outlet of the duct. The guide member can extend from an end of the slider toward the inlet of the duct and is slidably supported on the outer wall of the duct. For example, an inlet side end of the guide member can be connected to the end of the slider, and an outlet side end of the guide member can be slidably supported on the outer wall of the duct. With such a configuration, the opening amount of the outlet may be adjusted by moving the slider in the width direction of the print medium. Further, as the slider is moved, the inlet side end of the guide member can slide along the outer wall of the duct, and the guide member may be flexibly bent. Accordingly, the duct has a form that converges from the inlet to the outlet, and the cooling air introduced into the duct from the blower through the inlet can be naturally and effectively guided to the outlet and may be supplied to the non-passing area of the fuser.

As an example, the variable duct structure may have a pivot member. The pivot member may be pivotally connected to the end of the slider, and the guide member may be connected to the pivot member. Accordingly, the guide member and the pivot member together may allow the duct to have a form converging from the inlet toward the outlet. The pivot member may be guided by a guide groove. The guide groove may guide the pivot member so that an angle of the pivot member with respect to the slider gradually increases in a case where the slider is moved from a first position where the opening amount of the outlet is at a reduced size (e.g., a minimum) to a second position where the opening amount of the outlet is at an increased size (e.g., a maximum). For example, the angle of the pivot member with respect to the slider in a case where the slider is positioned at the first position and the second position is respectively a first angle and a second angle, and the second angle is greater than the first angle. According to such a configuration, even if the opening amount of the outlet is changed, the cooling air introduced into the duct from the blower through the inlet can be naturally and effectively guided to the outlet and may be supplied to the non-passing area of the fuser.

As an example, the print apparatus may include a toner cartridge supplying toner to the toner image forming portion. The blower may be positioned between the toner cartridge and the fuser. With respect to a blowing direction of the blower, the toner cartridge may be positioned on an upstream side of the blower, and the fuser may be positioned on a downstream side of the blower. Accordingly, the heat of the fuser may have a lesser effect on the toner cartridge.

As an example, the components of the above-described variable duct structure may be paired and symmetrically disposed in a width direction of the print medium. In this example, a pair of sliders may be driven by a rack-and-pinion driving structure. For example, a first rack gear portion and a second rack gear portion may be provided on a pair of sliders, that is, a first slider and a second slider, respectively, and the first rack gear portion and the second rack gear portion can engage with a pinion. A motor can rotate the pinion. As the motor rotates, the pair of sliders may be symmetrically moved in the width direction of the print medium. Such a driving structure may be applied to a small and limited space and may be implemented at a reduced cost because a pair of sliders may be driven by a single motor.

According to an example of the disclosure, a print apparatus may include a toner image forming portion to form a toner image on a print medium, a fuser to fuse the toner image onto the print medium, an air blower, a duct to guide cooling air from the blower to the fuser, the duct comprising an inlet formed to face the blower, an outlet facing the fuser, and an opening amount adjusting member to be slidable in a width direction of the print medium so as to adjust an opening amount of the outlet, and to allow the duct to have a form converging from the inlet toward the outlet.

According to an example of the disclosure, a print apparatus may include a toner image forming portion to form a toner image on a print medium, a toner cartridge to supply a toner to the toner image forming portion, a fuser to fuse the toner image to a print medium, a first duct and a second duct positioned symmetrically in a width direction of the print medium between the toner cartridge and the fuser and each comprising an inlet and an outlet facing the fuser, a first blower and a second blower to supply cooling air through the inlets of the first duct and the second duct, respectively, and a first opening amount adjusting member and a second aperture adjusting member to be slidable symmetrically with each other in the width direction of the print medium so as to adjust opening amounts of the outlets of the first duct and the second duct, respectively.

Hereinafter, examples of the print apparatus are described with reference to the drawings. In the drawings, the same reference numerals refer to components having the same function, and the size of each component may be exaggerated for clarity and convenience of description.

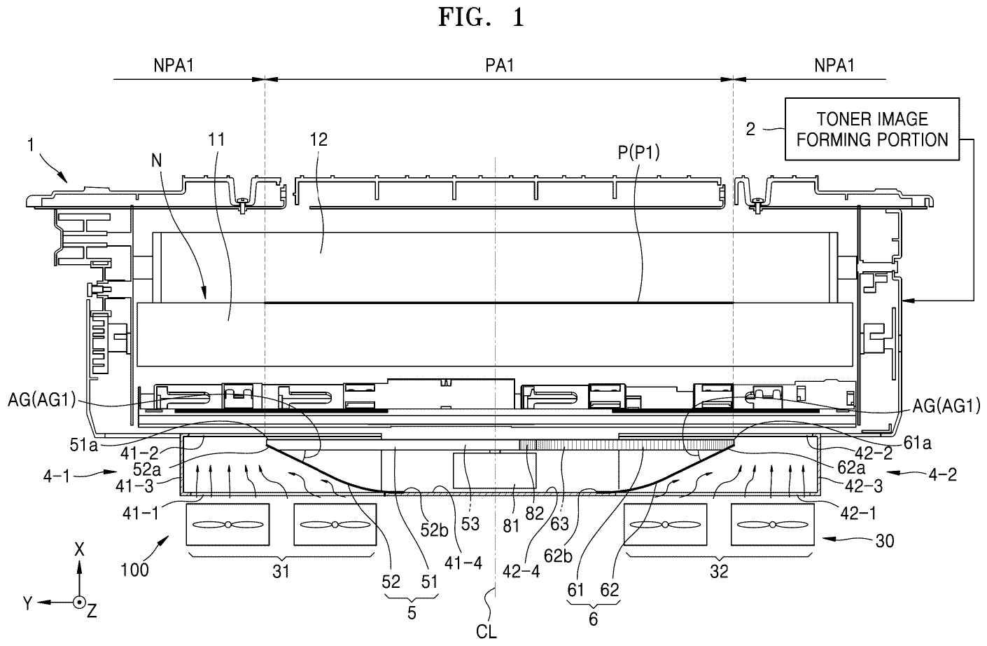

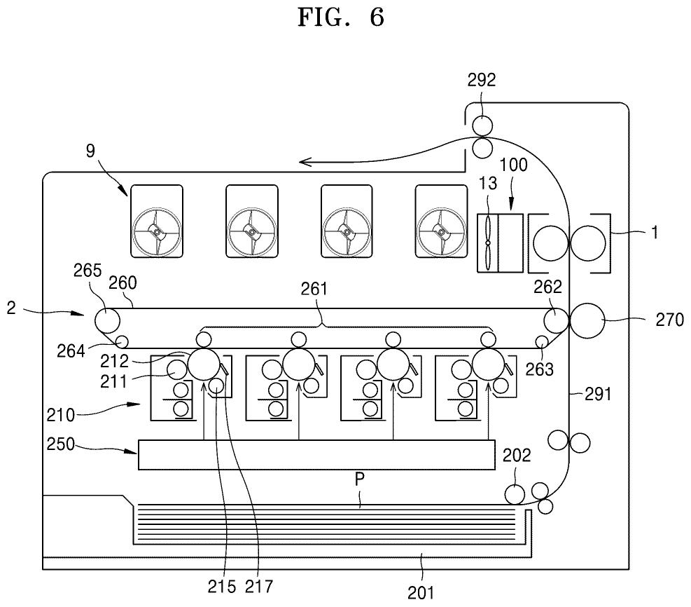

FIG. 1 is a schematic plan view of an example of a print apparatus and shows a state in which first and second sliders are positioned at a first position where opening amounts of outlets of first and second ducts are at a reduced size consistent with the disclosure. In FIG. 1, a variable duct structure related to cooling of the fuser 1 is shown in detail, and other components of the print apparatus are omitted. Referring to FIG. 1, a toner image forming portion 2 forms a toner image on a print medium P by an electrophotographic method. An example structure of the toner image forming portion 2 is described below in detail with reference to FIG. 6. X, Y, and Z indicate three directions orthogonal to each other, respectively. For example, the Y direction is a width direction of the print medium P, the Z direction is a direction in which the print medium P passes through a fusing nip N to be described below, and the X direction is a direction perpendicular to the Y direction and the Z direction.

The fuser 1 fuses the toner image by applying heat and pressure to the print medium P. For example, the fuser 1 includes a fusing member 11 and a backup member 12. The fusing member 11 and the backup member 12 engage with each other to form a fusing nip N. The print medium P passes through the fusing nip (FIG. 6: N) while being transported, for example, in the Z direction. Heat transfer from the fusing member 11 to the print medium P occurs in the fusing nip N.

The fusing member 11 may be, for example, a fusing roller. The fusing roller may include a hollow metal core. A release layer for improving separability may be provided on the outer periphery of the metal core. The release layer may include, for example, perfluoroalkoxy (PFA), polytetrafluoroethylenes (PTFE), and/or fluorinated ethylene prophylene (FEP). A heater, not shown, may be disposed inside the hollow metal core to heat the fusing roller. A halogen lamp may be employed as the heater. The backup member 12 may be a backup roller opposite the fusing roller. The backup roller may include a heat-resistant elastic layer. The fusing roller and the backup roller can be pressed against each other by an elastic member (not shown) to form the fusing nip N. The print medium P is transferred to the fusing nip N so that an image surface on which the toner image is formed faces the fusing roller, and in a case where the fusing roller and the backup roller rotate, the print medium P inside the fusing nip N may be transported.

The fusing member 11 may be, for example, a fusing belt. The fusing belt may include a flexible base layer (not shown). The base layer may include a thin metal film such as stainless steel, nickel, nickel copper, etc. The base layer may include a polymer film having heat resistance and abrasion resistance capable of withstanding a fusing temperature such as a polyimide film, a polyamide film, a polyimide amide film, etc. A release layer (not shown) may be provided on a surface of the base layer facing the backup member 12 or both surfaces of the base layer. The release layer may be a resin layer having a threshold separability. The release layer may include, for example, perfluoroalkoxy (PFA), polytetrafluoroethylenes (PTFE), fluorinated ethylene prophylene (FEP), etc. To form the fusing nip N with a desired width and flatness, an elastic layer (not shown) may be disposed between the base layer and the release layer. The elastic layer may include a material having heat resistance capable of withstanding the fusing temperature. For example, the elastic layer may include a rubber material such as fluororubber or silicone rubber. The backup member 12 may be a pressing roller facing the fusing belt. The pressing roller may include a heat-resistant elastic layer. A heater may be disposed inside the fusing belt to heat the fusing belt. A halogen lamp disposed inside the fusing belt, a ceramic heater that is in contact with the inner periphery of the fusing belt to directly heat the fusing belt, etc. may be employed as the heater. A support member may be disposed inside the fusing belt. The support member and the pressing roller can be pressed against each other with the fusing belt disposed therebetween to form the fusing nip N. The print medium P is transferred into the fusing nip N so that the image surface on which the toner image is formed faces the fusing belt, and in a case where the pressing roller rotates, the fusing belt circulates, and the print medium P inside the fusing nip N may be transported.

A control unit, not shown, controls a heater, not shown, so that the fusing nip N may be generally maintained at a fusing temperature. The print medium P may pass through the fuser 1 in a center feeding method. The center feeding method refers to a method of transporting the print medium P in a state where the center of the width direction Y of the print medium P coincides with the center of the width direction Y of the fuser 1, for example, a center line CL of the width direction Y of the fixing nip N. The width of the fusing nip N can be greater than the width of the print medium P of the largest desired size that may be used by the print apparatus. Therefore, even in a case where the print medium P of the largest desired size passes through the fusing nip N, an edge area of the fusing nip N in the width direction Y may be a non-passing area through which the print medium P does not pass. An area of the fusing nip N through which the print medium P passes can be referred to as a passing area. In a case where the print medium P of a small size passes through the area, the width of the non-passing area can increase. A direct heat transfer from the fuser 1, for example, the fusing member 11, to the print medium P, may not occur in the non-passing area, and thus, the temperature of the non-passing area may be relatively higher than that of the passing area, and the non-passing area may be more likely to overheat.

Overheating of the non-passing area may cause thermal damage to members constituting the fuser 1, such as the fusing member 11 and the backup member 12 and may reduce the life of the fuser 1. In addition, internal members of the print apparatus may be deformed or damaged by the heat generated by the fuser 1. For example, a photosensitive layer of a photosensitive member to be described below may be damaged by heat. In addition, the physical property of toner contained in the toner cartridge to be described below may deteriorate due to heat.

In order to prevent overheating of the non-passing area, the print apparatus may have a cooling structure supplying cooling air to the non-passing area. Referring to FIG. 1, the cooling structure may include a blower (e.g., a first blower) 31 and a duct (e.g., a first duct) 4-1. The blower 31 can provide cooling air to the fuser 1. A blowing direction of the blower 31 is, for example, the X direction. Although two blowers 31 are shown in the present example, the number of blowers 31 may be one, three, or more. The duct 4-1 can guide the cooling air from the blower 31 to the fuser 1. The duct 4-1 may have an inlet 41-1 facing the blower 31, and an outlet 41-2 facing the fuser 1. For example, the duct 4-1 may include an outer wall 41-4 facing the blower 31. The inlet 41-1 may be formed by being opened in the outer wall 41-4. The outlet 41-2 can be positioned to face the inlet 41-1 in a blowing direction X. A side wall (e.g., a first side wall) 41-3 can form one side wall in a width direction of the duct 4-1. The cooling air introduced into the duct 4-1 through the inlet 41-1 by the blower 31 can be discharged to the fuser 1 through the outlet 41-2. As described above, the width of the non-passing area may vary according to the width of the print medium P used. In a case where the cooling air is supplied to the passing area, the temperature of the passing area may not be maintained at the fusing temperature, and the fusing quality may deteriorate.

The cooling structure employed in the print apparatus of the disclosure may have a variable duct structure 100 to supply cooling air in response to a change in the width of the non-passing area. The print apparatus according to an example of the disclosure includes an opening amount adjusting member (e.g., a first opening amount adjusting member) 5 for adjusting the opening amount of the outlet 41-2, as an example of the variable duct structure 100 The opening amount of the outlet 41-2 may be adjusted in accordance with the width of the non-passing area by the opening amount adjusting member 5. The opening amount adjusting member 5 may adjust the opening amount of the outlet 41-2 of the outlet 41-2 in the width direction Y of the print medium P. For example, the opening amount adjusting member 5 may slide in the width direction Y to adjust the opening amount of the outlet 41-2. In order to ensure a natural flow of cooling air from the inlet 41-1 to the outlet 41-2, the opening amount adjusting member 5 may allow the duct 4-1 to have a form converging from the inlet 41-1 toward the outlet 41-2.

An example of the opening amount adjusting member 5 may include a slider (e.g., a first slider) 51 and a flexible guide member (e.g., a first guide member) 52. The slider 51 may slide in the width direction Y of the print medium P to adjust the opening amount of the outlet 41-2. The outlet 41-2 can be formed between an end portion 51a of the slider 51 and the side wall 41-3. The guide member 52 may include an outlet side end portion 52a and an inlet side end portion 52b. The outlet side end portion 52a is connected to the end portion 51a of the slider 51. The end portion 51a of the slider 51 is an end portion farther from the center line CL of the fusing nip N in the width direction Y among both ends of the slider 51 in the width direction Y. The inlet side end portion 52b is slidably supported on the outer wall 41-4 of the duct 4-1, for example, in the width direction Y. For example, the inlet side end portion 51b is slidably supported on the inner surface of the outer wall 41-4, that is, the surface of the outer wall 41-4 facing the fuser 1. For example, although not shown in the drawings, a support structure, for instance, a sliding support groove, a sliding support rail, etc., slidably supporting the inlet side end portion 52b of the guide member 52 in the width direction Y may be provided in the outer wall 41-4, and a guide structure slidably guided to the support structure may be provided in the inlet side end portion 52b of the guide member 52. The support structure and the guide structure may be implemented in complementary shapes. The guide member 52 can extend from the end portion 51a of the slider 51 to the outer wall 41-4 of the duct 4-1 while forming an angle AG with respect to the slider 51, that is, with respect to the width direction Y. The angle AG may be an acute angle. The guide member 52 may be implemented by a flexible sheet having elasticity. For example, the guide member 52 may include a polycarbonate (PC) film, etc. Thereby, the guide member 52, together with the side wall 41-3, can allow the duct 4-1 to have a form converging from the inlet 41-1 toward the outlet 41-2. The width of the outlet 41-2 may be smaller than the width of the inlet 41-1. The duct 4-1 formed by the guide member 52 and having the form converging from the inlet 41-1 to the outlet 41-2 can guide the cooling air introduced into the duct 4-1 through the inlet 41-1 naturally toward the outlet 41-2. Thereby, the flow resistance of the cooling air, and noise resulting therefrom, may be reduced.

The slider 51 may be slidably driven in the width direction Y of the print medium P by, for example, a rack-and-pinion driving structure. Referring to FIG. 1, a rack gear portion (e.g., a first rack gear portion) 51c may be provided on the slider 51. The rack gear portion 51c engages with a pinion 82, and a motor 81 rotates the pinion 82. For example, the pinion 82 may be coupled to a rotation shaft of the motor 81. With such a configuration, the slider 51 may slide in the width direction Y of the print medium P by rotating the motor 81 forward/backward, and accordingly, the opening amount of the outlet 41-2 of the duct 4-1 may be adjusted.

As described above, in the print apparatus of the disclosure, the print medium P can be transported in the center feeding method. Accordingly, non-passing areas are respectively formed on both outer sides of the print medium P in the width direction Y, and cooling air may be supplied to the two non-passing areas. To this end, referring to FIG. 1, the print apparatus includes a second blower 32 and a second duct 4-2. The second blower 32 provides cooling air to the fuser 1. A blowing direction of the second blower 32 is, for example, the X direction. Two second blowers 32 are shown in the present example, but the number of second blowers 32 may be more or fewer than two. The second duct 4-2 can be positioned symmetrically with the first duct 4-1 with respect to the center line CL in the width direction Y of the print medium P. The structure of the second duct 4-2 can be symmetrical to the structure of the first duct 4-1 with respect to the center line CL in the width direction Y of the print medium P. The second duct 4-2 can guide the cooling air from the second blower 32 to the fuser 1. The second duct 4-2 can include an inlet 42-1 facing the second blower 32, and an outlet 42-2 facing the fuser 1. For example, the second duct 4-2 may have an outer wall 42-4 facing the second blower 32. The inlet 42-1 may be formed by being opened in the outer wall 42-4. The outlet 42-2 is positioned to face the inlet 42-1 in a blowing direction X. A side wall (e.g., a second side wall) 42-3 forms one side wall of the second duct 4-2 in the width direction Y. Cooling air introduced into the second duct 4-2 through the inlet 42-1 by the second blower 32 can be discharged to the fuser 1 through the outlet 42-2.

The print apparatus according to an example of the disclosure includes a second opening amount adjusting member 6 for adjusting an opening amount of the outlet 42-2 of the second duct 4-2. The second aperture amount adjusting member 6 can be positioned symmetrically with the first aperture amount adjusting member 5 with respect to the center line CL in the width direction Y of the print medium P. The structure of the second opening amount adjusting member 6 can be symmetrical with the structure of the first opening amount adjusting member 5 with respect to the center line CL in the width direction Y of the print medium P. The second opening amount adjusting member 6 may slide symmetrically with the first opening amount adjusting member 5 in the width direction Y of the print medium P, and thus, the opening amount of the outlet 42-2 of the second duct 4-2 may be adjusted. In order to allow for a natural flow of the cooling air from the inlet 42-1 to the outlet 42-2, the second opening amount adjusting member 6 may allow the second duct 4-2 to have a form converging from the inlet 42-1 toward the outlet 42-2.

An example of the second opening amount adjusting member 6 may include a second slider 61 and a flexible second guide member 62. The second slider 61 may slide symmetrically with the first slider 51 in the width direction Y of the print medium P in order to adjust the opening amount of the outlet 42-2. The outlet 42-2 is formed between an end portion 61a of the second slider 61 and the side wall 42-3. An outlet side end portion 62a of the second guide member 62 is connected to the end portion 61a of the second slider 61, and an inlet side end portion 62b can be slidably supported on the outer wall 42-4 of the second duct 4-2, for example, in the width direction Y of the print medium P. The outer wall 41-4 of the first duct 4-1 and the outer wall 42-4 of the second duct 4-2 may be integrally formed. For example, although not shown in the drawings, a support structure slidably supporting the inlet side end portion 62b of the second guide member 62 in the width direction Y may be provided on the outer wall 42-4, and a guide structure slidably guided to the support structure may be provided in the inlet side end portion 62b of the second guide member 62. The second guide member 62 extends from the end portion 61a of the second slider 61 to the outer wall 42-4 of the second duct 4-2 while forming, for example, the angle AG, which is an acute angle, with respect to the second slider 61, that is, with respect to the width direction Y of the print medium P. The second guide member 62 may be implemented by a flexible sheet having elasticity. For example, the second guide member 62 may include a polycarbonate (PC) film, etc. Thereby, the second guide member 62, together with the side wall 42-3, can allow the second duct 4-2 to have a form converging from the inlet 42-1 toward the outlet 42-2. The second duct 4-2 formed by the second guide member 62 and having the form converging from the inlet 42-1 to the outlet 42-2 can guide the cooling air introduced into the second duct 4-2 through the inlet 42-1 naturally toward the outlet 42-2. Thereby, the flow resistance of the cooling air, and noise resulting therefrom may be reduced.

The second slider 61 may be slidably driven in the width direction Y of the print medium P by, for example, a rack-and-pinion driving structure. A second rack gear portion 61b may be provided on the second slider 6, and the second rack gear portion 61b may engage with the pinion 82. For example, the first rack gear portion 51c and the second rack gear portion 61b face each other in the vertical direction Z with the pinion 82 disposed therebetween. With such a configuration, in a case where the motor 81 rotates the pinion 82, the first and second sliders 51 and 61 can slide symmetrically with each other in the width direction Y of the print medium P, and, accordingly, the opening amount of each of the outlets 41-2 and 42-2 of the first and second ducts 4-1 and 4-2 may be adjusted. The driving structure driving each of the first and second opening amount adjusting members 5 and 6 may be arranged in an available space between the first and second ducts 4-1 and 4-2 in the width direction Y of the print medium P. Accordingly, an additional space for the driving structure may not be secured, and thus, an increase in the size of the print apparatus may be reduced. In addition, the rack-and-pinion driving structure can enable a compact driving structure that can simultaneously drive the first and the second sliders 51 and 61.

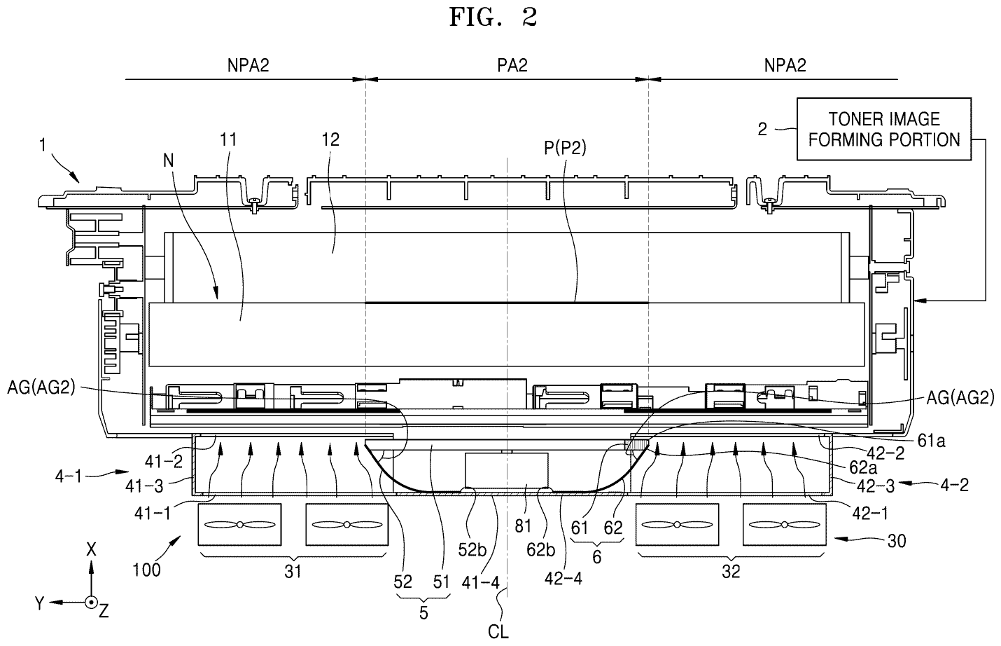

FIG. 1 shows that the first and the second sliders 51 and 61 are positioned in the first position where the opening amounts of the outlets 41-2 and 42-2 of the first and second ducts 4-1 and 4-2 are reduce. FIG. 2 is a schematic plan view of an example of a print apparatus and shows a state in which the first and the second sliders 51 and 61 are positioned at a second position where opening amounts of outlets 41-2 and 42-2 of first and second ducts 4-1 and 4-2 are at an increased size consistent with the disclosure. Referring to FIGS. 1 and 2, the operation of the variable duct structure is described.

First, referring to FIG. 1, a largest print medium P1 can be used for printing. The print medium P1 passes through the fuser 1 in a center feeding method. An area of the fusing nip N through which the print medium P1 passes is a passing area PA1. For example, a width of the passing area PA1 is equal to the width of the print medium P1. The print medium P1 may not pass through two non-passing areas NPA1 on both sides of the passing area PA1. A width of the non-passing area NPA1 can be at a reduced size. A control unit (not shown) may drive the motor 81 according to width information of the print medium P1 detected or input by the user to move the first and the second sliders 51 and 61 to the first position where the opening amounts of the outlets 41-2 and 42-2 of the first and the second ducts 4-1 and 4-2 are at a reduced size. The first and the second guide members 52 and 62 can have an angle AG1 which is an acute angle with respect to the first and the second sliders 51 and 61, respectively, that is, with respect to the width direction Y of the print medium P. Accordingly, the first and the second ducts 4-1 and 4-2 can have a structure converging from the inlets 41-1 and 42-1 to the outlets 41-2 and 42-2. Cooling air supplied by the first and second blowers 31 and 32 in a blowing direction X may be introduced into the first and second ducts 4-1 and 4-2, respectively, through the inlets 41-1 and 42-1, can be naturally discharged to the outlets 41-2 and 42-2 along the converging flow passage, and can be supplied to the two non-passing areas NPA1 of the fuser 1. Thereby, overheating of the two non-passing areas NPA1 may be reduced (e.g., prevented) in a case where a largest print medium P1 passes through the fuser 1.

Next, referring to FIG. 2, a smallest print medium P2 can be used for printing. The print medium P2 passes through the fuser 1 in the center feeding method. An area of the fusing nip N through which the print medium P2 passes is a passing area PA2, and widths of two non-passing areas NPA2 on both sides of the passing area PA2 are of an increased size. A control unit (not shown) may drive the motor 81 according to width information of the print medium P2 detected or input by the user to move the first and the second sliders 51 and 61 to the second position where the opening amounts of the outlets 41-2 and 42-2 of the first and second ducts 4-1 and 4-2 are at an increased opening size. The inlet side end portions 52b and 62b of the first and second guide members 52 and 62 can slide along the outer walls 41-4 and 42-4 of the first and second ducts 4-1 and 4-2 in the width direction Y, and the first and second guide members 52 and 62 can be flexibly bent. In the second position, the first and the second guide members 52 and 62 each have an angle AG2 which is an acute angle with respect to the first and the second sliders 51 and 61, that is, with respect to the width direction Y of the print medium P. The angle AG2 may be equal to or greater than the angle AG1. The angle AG2 may be determined according to elasticity of the first and second guide members 52 and 62. The first and the second ducts 4-1 and 4-2 can have a structure converging from the inlets 41-1 and 42-1 toward the outlets 41-2 and 42-2. Cooling air supplied by the first and the second blowers 31 and 32 in a blowing direction X can be introduced into the first and the second ducts 4-1 and 4-2, respectively, through the inlets 41-1 and 42-1, can be naturally discharged to the outlets 41-2 and 42-2 along the converging flow passage, and can be supplied to the two non-passing areas NPA2 of the fuser 1. Thereby, overheating of the two non-passing areas NPA2 may be reduced (e.g., prevented) in a case where a smallest print medium P2 passes through the fuser 1.

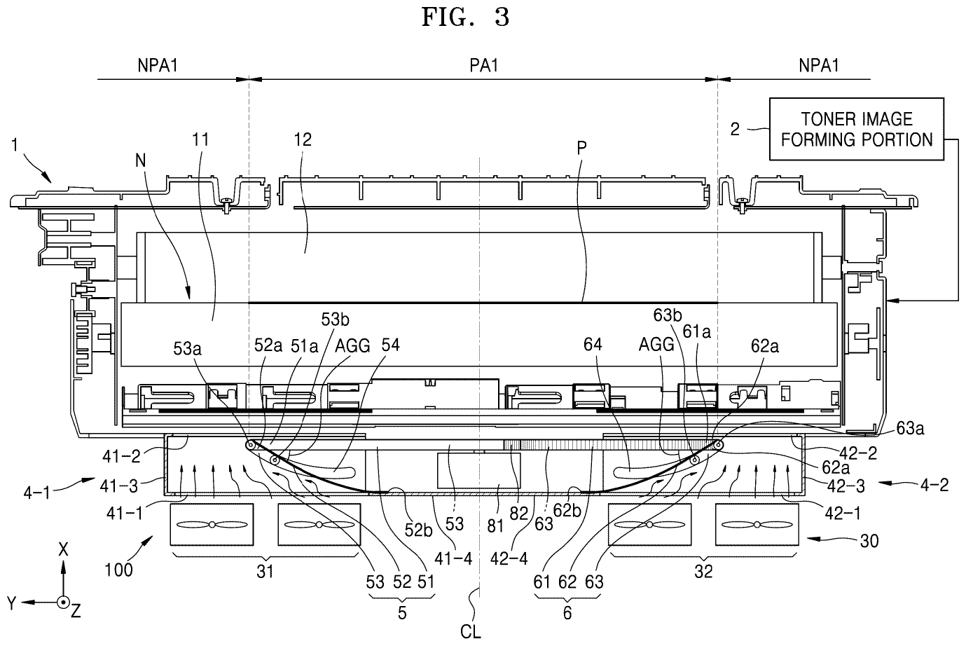

FIG. 3 is a schematic plan view of an example of a print apparatus consistent with the disclosure. The print apparatus of the present example is different from the examples of the print apparatuses shown in FIGS. 1 and 2 in that an opening amount adjusting member further includes a pivot member. Hereinafter, the same members are given the same reference numerals, redundant descriptions are omitted, and differences are described. Referring to FIG. 3, the opening amount adjusting member 5 includes a pivot member (e.g., a first pivot member) 53 pivotably connected to the end portion 51a of the slider (e.g., a first slider) 51. The outlet side end portion 52a of the guide member (e.g., the first guide member) 52 is connected to the pivot member 53. The guide member 52 and the pivot member 53 can allow the duct (e.g., the first duct) 4-1 to have a form converging from the inlet 41-1 to the outlet 41-2.

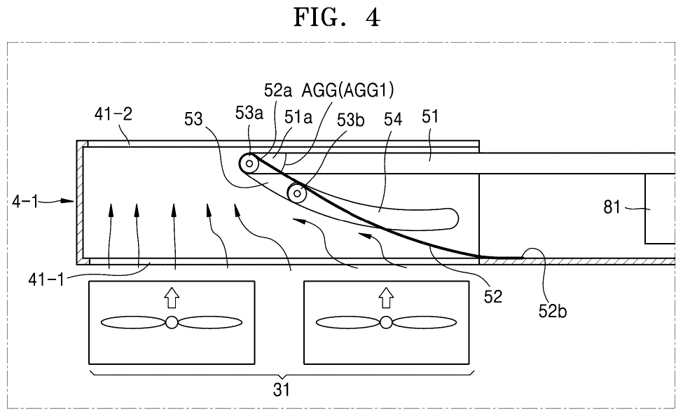

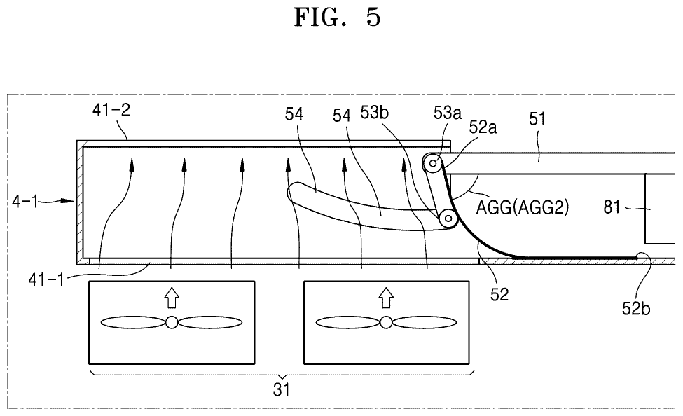

The pivot member 53 has an angle AGG with respect to the slider 51, that is, with respect to the width direction Y of the print medium P. The pivot member 53 can be guided by a guide groove (e.g., a first guide groove) 54 so that the angle AGG changes as the slider 51 slides in the width direction Y. In the present example, the guide groove 54 guides the pivot member 53 so that the angle AGG gradually increases as the slider 51 moves in a direction in which the opening amount of the outlet 41-2 increases, for example, in a direction toward the center line CL. To this end, the guide groove 54 is formed to be farther away from the slider 51 as being closer to the center line CL. For example, the first end 53a of the pivot member 53 forms a pivot axis pivotably connected to the end portion 51a of the slider 51. The pivot axis may be in the vertical direction Z in FIG. 3. A second end portion 53b of the pivot member 53 can be inserted into the guide groove 54 to form a guide protrusion. In a case where the angle AGG at which the slider 51 is positioned in the first position where the opening amount of the outlet 41-2 is reduced is a first angle (e.g., FIG. 4: AGG1), and the angle AGG at which the slider 51 is positioned in the second position where the opening amount of the outlet 41-2 is increased is a second angle (e.g., FIG. 5: AGG2), the guide groove 54 can guide the pivot member 53 so that the second angle AGG2 is greater than the first angle AGG1.

The second opening amount adjusting member 6 includes a second pivot member 63 pivotally connected to an end portion 61a of the second slider 61. An outlet side end portion 62a of the second guide member 62 is connected to the second pivot member 63 The second guide member 62 and the second pivot member 63 can allow the second duct 4-2 to have a form converging from the inlet 42-1 to the outlet 42-2. The second pivot member 63 can be positioned symmetrically with the first pivot member 53 in the width direction Y of the print medium P. The second pivot member 63 has the angle AGG with respect to the second slider 61, that is, with respect to the width direction Y of the print medium P, and can be guided by a second guide groove 64 so that the angle AGG gradually increases as the second slider 61 moves in a direction in which the opening amount of the outlet 42-2 of the second duct 4-2 increases, for example, in a direction toward the center line CL. To this end, the second guide groove 64 is formed to be farther away from the second slider 61 as being closer to the center line CL. For example, a first end portion 63a of the second pivot member 63 forms a pivot axis pivotably connected to the end portion 61a of the second slider 61. The second end 63b of the second pivot member 63 is inserted into the second guide groove 64 to form a guide protrusion. In a case where the angle AGG at which the second slider 61 is positioned in the first position where the opening amount of the outlet 42-2 of the second duct 4-2 is reduced is the first angle AGG1, and the angle AGG at which the second slider 51 is positioned in the second position where the opening amount of the outlet 42-2 of the second duct 4-2 is increased is the second angle AGG2, the second guide groove 64 can guide the second pivot member 63 so that the second angle AGG2 is greater than the first angle AGG1.

FIG. 4 shows a state in which, in the example of the print apparatus shown in FIG. 3, the first slider 51 is positioned at the first position where the opening amount of the outlet 41-2 of the first duct 4-1 is at the reduced size consistent with the disclosure. FIG. 5 shows a state in which, in the example of the print apparatus shown in FIG. 3, the first slider 51 is positioned at the second position where the opening amount of the outlet 41-2 of the first duct 4-1 is at the increased size consistent with the disclosure.

Although not shown in FIGS. 4 and 5, the second slider 61 can be positioned symmetrically with the first slider 51 in the width direction Y. Referring to FIGS. 4 and 5, the operation of the variable duct structure shown in FIG. 3 is described. The print media P1 and P2, the passing areas PA1 and PA2, and the non-passing areas NPA1 and NPA2 are with reference to FIGS. 1 and 2.

First, referring to FIG. 4, a largest print medium P1 can be used for printing. The print medium P1 passes through the fuser 1 in a center feeding method. An area of the fusing npi N through which the print medium P1 passes is the passing area PA1, and the print medium P1 does not pass through the two non-passing areas NPA1 on both sides of the passing area PA1. A width of the non-passing area NPA1 can be at a reduced size. A control unit (not shown) may drive the motor 81 according to width information of the print medium P1 detected or input by a user to move the first and second sliders 51 and 61 to the first position where the opening amounts of the outlets 41-2 and 42-2 of the first and second ducts 4-1 and 4-2 are at a reduced size. The first and second guide members 52 and 62 and the first and second pivot members 53 and 63 respectively can have the first angle AGG1 that is an acute angle with respect to the first and second sliders 51 and 61, that is, with respect to the width direction Y of the print medium P. By the first and second pivot members 53 and 63 and the first and second guide members 52 and 62, the first and second ducts 4-1 and 4-2 each have a structure converging from the inlets 41-1 and 42-1 toward the outlets 41-2 and 42-2. Cooling air supplied by the first and second blowers 31 and 32 in the blowing direction Y can be introduced into the first and second ducts 4-1 and 4-2, respectively, through the inlets 41-1 and 42-1, can be naturally discharged to the outlets 41-2 and 42-2 along the converging flow passage, and can be supplied to the two non-passing areas NPA1 of the fuser 1. Thereby, overheating of the two non-passing areas NPA1 may be reduced (e.g., prevented) in a case where a largest print medium P1 passes through the fuser 1.

Next, referring to FIG. 5, a smallest print medium P2 can be used for printing. The print medium P2 can pass through the fuser 1 in the center feeding method. An area of the fusing nip N through which the print medium P2 passes can be the passing area PA2, and widths of the two non-passing areas NPA2 on both sides of the passing area PA2 are at an increased size. A control unit (not shown) may drive the motor 81 according to width information of the print medium P2 detected or input by the user to move the first and second sliders 51 and 61 to the second position where the opening amounts of the outlets 41-2 and 42-2 of the first and second ducts 4-1 and 4-2 are at the increased size. As the first and the second sliders 51 and 61 move toward the center line CL, the first and the second pivot members 53 and 63 can be guided to the first and the second guide grooves 54 and 64 so that the angle AGG gradually increases from the first angle AGG1. The inlet end portions 52b and 62b of the first and second guide members 52 and 62 can slide along the outer walls 41-4 and 42-4 of the first and second ducts 4-1 and 4-2, and the first and the second guide members 52 and 62 can be flexibly bent. In the second position, the first and the second pivot members 53 and 63 and the first and the second guide members 52 and 62 can have the second angle AGG2 which is an acute angle with respect to the first and second sliders 51 and 61 (e.g., with respect to the width direction Y of the print medium P). The second angle AGG2 can be greater than the first angle AGG1. By the first and second pivot members 53 and 63 and the first and second guide members 52 and 62 the first and second ducts 4-1 and 4-2 each have a structure converging from the inlets 41-1 and 42-1 toward the outlets 41-2 and 42-2. The cooling air supplied in the blowing direction (X) by the first and the second blowers 31 and 32 can be first and second ducts 4-1 through inlets 41-1 and 42-1, respectively. It can be naturally discharged to the outlets 41-2, 42-2 along the converging flow passage, and can be supplied to the two non-passing areas NPA2 of the fuser 1. In this example, the second angle AGG2 is greater than the angle AG2 of FIG. 2. Accordingly, cooling air introduced through the inlets 41-1 and 42-1 may be guided to the first and second pivot members 53 and 63 and the first and second guide members 52 and 62 and further naturally discharged to the outlets 41-2 and 42-2. Thereby, overheating of the two non-passing areas NPA2 may be reduced (e.g., prevented) in a case where the smallest print medium P2 passes through the fuser 1.

FIG. 6 is a schematic configuration diagram of an example of a print apparatus consistent with the disclosure. Referring to FIG. 6, the example of the print apparatus includes the toner image forming portion 2 that forms a toner image on the print medium P, the fuser 1, and a cooling structure for supplying cooling air to a non-passing area of the fuser 1. The cooling structure may include the blower 13, which may be analogous to blower 30, and the variable duct structure 100. The variable duct structure 100 may have the structure described with reference to FIGS. 1 to 5. The variable duct structure 100 may include the first and second opening amount adjusting members 5 and 6. The blower 13 may include the first and second blowers 31 and 32.

The toner image forming portion 2 can supply toner to an electrostatic latent image formed on a photosensitive member, for example, the photosensitive drum 212, and can develop the electrostatic latent image into a toner image. The example of the print apparatus may include a toner cartridge 9 in which toner to be supplied to the toner image forming portion 2 is accommodated. The toner image forming portion 2 can form the toner image on the print medium P by an electrophotographic method. The toner image forming portion 2 of the present example can form a color toner image on the print medium P by the electrophotographic method.

The toner image forming portion 2 may include a plurality of developing devices 210, an exposure device 250, an intermediate transfer belt 260, a transfer roller 270, and a fuser. The plurality of developing devices 210 may include four developing devices 210 for forming toner images of yellow (Y), magenta (M), cyan (C), and black (K) colors. Developers of cyan (C), magenta (M), yellow (Y), and black (K) colors, for example, toners, may be accommodated in the four developing devices 210, respectively. The toners of yellow (Y), magenta (M), cyan (C), and black (K) colors are accommodated in the four toner cartridges 9, respectively. The toners of yellow (Y), magenta (M), cyan (C), and black (K) colors may be supplied from the four toner cartridges 9 to the four developing devices 210, respectively. The developing device 210 may include a photosensitive drum 212 on which an electrostatic latent image is formed and a developing roller 211. The developing device 210 can supply toner to the electrostatic latent image to develop the electrostatic latent image into a visible toner image.

A charging roller 215 can charge the photosensitive drum 212 to have a uniform surface electric potential. The exposure device 250 can irradiate the photosensitive drum 212 with light modulated corresponding to image information to form an electrostatic latent image on the photosensitive drum 212. The developing roller 211 can supply the toner stored in the developing device 210 to a developing area facing the photosensitive drum 212. The toner can be supplied to the electrostatic latent image across the developing area by a developing bias voltage applied to the developing roller 211, and the electrostatic latent image can be developed into a visible toner image. The intermediate transfer belt 260 can be supported by and circulate around a plurality of support rollers 262, 263, 264, and 265. In some examples, four intermediate transfer rollers 261 are disposed at positions facing the photosensitive drums 212 of the four developing devices 210 with the intermediate transfer belt 260 disposed therebetween. The toner image developed on the photosensitive drum 212 can be intermediately transferred to the intermediate transfer belt 260 by an intermediate transfer bias voltage applied to the intermediate transfer roller 261. A cleaning member 217 can remove the developer remaining on the surface of the photosensitive drum 212 after an intermediate transfer process. The transfer roller 270 can be positioned to face the intermediate transfer belt 260 to form a transfer nip. The print medium P can be picked up by a pickup roller 202 from a paper feed cassette 201 and fed to the transfer nip along a path 291. The toner image on the intermediate transfer belt 260 can be transferred to the print medium P by the transfer bias voltage applied to the transfer roller 270. The fuser 1 can apply heat and pressure to the toner image transferred to the print medium P to fuse the toner image on the print medium P. The print medium P on which printing is completed can be discharged by a discharge roller 292.

The blower 13 may be positioned between the toner cartridge 9 and the fuser 1. For example, the toner cartridge 9, the blower 13, and the fuser 1 may be sequentially arranged in the X direction. A blowing direction of the blower 13 may be the X direction. Accordingly, with respect to the blowing direction X of the blower 13, the toner cartridge 9 may be positioned on an upstream side of the blower 13, and the fuser 1 may be positioned on a downstream side of the blower 13. According to such a configuration, cooling air can be supplied from the toner cartridge 9 toward the fuser 1, and thus, heat transfer from the fuser 1 to the toner cartridge 9 may be reduced, and aggregation, deformation, and deterioration of properties of the toner inside the toner cartridge 9 due to heat may be reduced or prevented.

Although the disclosure has been described with reference to the examples shown in the drawings, it will be understood that these are examples, and that various modifications and equivalent other examples are possible.

What is claimed is:

1. A print apparatus comprising:
a toner image forming portion to form a toner image on a print medium;
a fuser to fuse the toner image onto the print medium;
an air blower;
a duct to guide cooling air from the blower to the fuser, the duct comprising an outer wall, an inlet formed in the outer wall facing the blower, and an outlet facing the fuser;
a slider that is slidable in a width direction of the print medium to adjust an opening amount of the outlet; and
a flexible guide member having an outlet side end portion connected to an end portion of the slider and having an inlet side end portion slidably supported on the outer wall of the duct.

2. The print apparatus of claim 1, wherein the flexible guiding member allows the duct to have a form converging from the inlet toward the outlet.

3. The print apparatus of claim 1, further comprising:
a pivot member pivotally connected to the end portion of the slider,
wherein the outlet side end portion of the guide member is connected to the pivot member.

4. The print apparatus of claim 3, wherein the guide member and the pivot member allow the duct to have a form converging from the inlet toward the outlet.

5. The print apparatus of claim 3, wherein:
the slider has a first position where the opening amount of the outlet is at a reduced size and a second position where the opening amount of the outlet is at an increased size; and
the print apparatus further comprising:
a guide groove to guide the pivot member so that the pivot member forms a first angle and a second angle greater than the first angle with respect to the slider in response to the slider being positioned in the first position and the second position, respectively.

6. The print apparatus of claim 1, further comprising:
a toner cartridge to supply a toner to the toner image forming portion,
wherein the blower is positioned between the toner cartridge and the fuser.

7. The print apparatus of claim 6, wherein:
the toner cartridge is positioned on an upstream side of the blower; and
the fuser is positioned on a downstream side of the blower with respect to a blowing direction of the blower.

8. The print apparatus of claim 1, wherein:
the duct comprises a first duct and a second duct that are symmetrically positioned in the width direction of the print medium;
the blower comprises a first blower and a second blower respectively corresponding to the first duct and the second duct;
the slider comprises a first slider and a second slider respectively corresponding to the first duct and the second duct; and
the guide member comprises a first guide member and a second guide member respectively connected to the first slider and the second slider.

9. The print apparatus of claim 8, further comprising:
a first rack gear portion and a second rack gear portion respectively on the first slider and the second slider;
a pinion engaging with the first rack gear portion and the second rack gear portion; and
a motor to rotate the pinion.

10. A print apparatus comprising:
a toner image forming portion to form a toner image on a print medium;
a fuser to fuse the toner image onto the print medium;
an air blower;
a duct to guide cooling air from the blower to the fuser, the duct comprising an inlet formed to face the blower, and an outlet facing the fuser; and
an opening amount adjusting member that is slidable in a width direction of the print medium to adjust an opening amount of the outlet and to allow the duct to have a form converging from the inlet toward the outlet.

11. The print apparatus of claim 10, wherein the opening amount adjusting member comprises:
a slider that is slidable in the width direction of the print medium between a first position where the opening amount of the outlet is at a reduced size and a second position where the opening amount of the outlet is at an increased size;
a pivot member pivotably connected to an end portion of the slider and having an angle with respect to the slider changing as the slider slides; and
a flexible guide member having an outlet side end portion connected to the pivot member and an inlet side end portion slidably supported on an outer wall of the duct in which the inlet is formed.

12. The print apparatus of claim 11, further comprising a guide groove to guide the pivot member so that an angle of the pivot member with respect to the slider increases as the slider slides from the first position to the second position.

13. The print apparatus of claim 11, wherein:
the duct comprises a first duct and a second duct that are symmetrically positioned in the width direction of the print medium;
the blower comprises a first blower and a second blower respectively corresponding to the first duct and the second duct; and
the opening amount adjusting member comprises a first opening amount adjusting member and a second aperture adjusting member corresponding to the first duct and the second duct, respectively, and being slideable in the width direction of the print medium to be symmetrical with each other.

14. A print apparatus comprising:
a toner image forming portion to form a toner image on a print medium;
a toner cartridge to supply a toner to the toner image forming portion;
a fuser to fuse the toner image to a print medium;
a first duct and a second duct positioned symmetrically in a width direction of the print medium between the toner cartridge and the fuser and each comprising an inlet and an outlet facing the fuser;
a first blower and a second blower to supply cooling air through the inlets of the first duct and the second duct, respectively; and
a first opening amount adjusting member and a second aperture adjusting member that are slidable symmetrically with each other in the width direction of the print medium to adjust opening amounts of the outlets of the first duct and the second duct, respectively.

15. The print apparatus of claim 14, wherein each of the first opening amount adjusting member and the second aperture adjusting member comprises:
a slider that is slidable in the width direction of the print medium between a first position where the opening amount of the outlet is at a reduced size and a second position where the opening amount of the outlet is at an increased size;
a pivot member pivotally connected to an end portion of the slider;
a guide groove to guide the pivot member so that the pivot member forms a first angle and a second angle greater than the first angle with respect to the slider responsive to the slider positioned in the first position and the second position, respectively; and
a flexible guide member having an outlet side end portion connected to the pivot member and an inlet side end portion slidably supported on an outer wall of the duct in which the inlet is formed.
